(19) United States
(12) Patent Application Publication
(10) Pub. No.: US 2024/0031808 A1
(43) Pub. Date: Jan. 25, 2024

(54) USER DEFINED NETWORK SERVICE AUTHORIZATION BASED ON SECONDARY IDENTITY CREDENTIALS

(71) Applicant: Cisco Technology, Inc., San Jose, CA (US)

(72) Inventors: Srinath Gundavelli, San Jose, CA (US); Stephen Orr, Wallkill, NY (US); Shree Murthy, San Jose, CA (US); Pradeep Kumar Kathail, Los Altos, CA (US)

(21) Appl. No.: 17/871,737

(22) Filed: Jul. 22, 2022

(51) Int. Cl. H04W 12/06; H04W 12/08; H04W 12/76

(52) U.S. Cl. CPC H04W 12/068; H04W 12/08; H04W 12/76

(57) ABSTRACT

This disclosure describes techniques and mechanisms for performing user defined network (UDN) service authorization based on secondary identity credentials within a wireless network. For instance, the techniques may include receiving, from a user device, a first request to access a wireless network (e.g., such as a WLAN), where the first request may include primary access credentials for accessing the WLAN. Once primary access authentication of the user device is complete, the techniques may include receiving a second request from the user device to access a UDN group within the wireless network. The second request can include secondary credentials for accessing the UDN group. In response to the second request, a secondary EAP dialogue may be established to authenticate the user device using the secondary credentials. Once the secondary credentials are authenticated, the techniques may include granting the user device access to the UDN group.

### TECHNICAL FIELD

The present disclosure relates generally to the field of networking, and more particularly to techniques for providing second credentials for a user defined network (UDN) service authorization and simplifying UDN configuration.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

Within the networks, user defined networks (UDNs) may be offered. A UDN is a construct in the enterprise networks for creating logical private groups. The UDN concept is about allowing an end-user to create a private network, which helps in limiting scope for service-discovery, realizing traffic segmentation, and enforcing access controls at the group level.

Currently, users have the ability to create their own UDN in a shared environment. For instance, an end user may manually configure a UDN using an application, self-registering with a cloud service, or through a policy engine. When creating the UDN, the end user registers the identity (e.g., MAC addresses) of the user(s) and devices that may access and/or communicate with the UDN. The cloud service may assign a unique identity to the new UDN group and the unique identifier is then communicated to the infrastructure to enforce segmentation and traffic containment policies within the network. Users and devices may switch between UDN groups through an explicit invite and accept workflow, where the invite and accept workflow is initiated each time a user and/or device access the UDN group and/or tries to switch to a new UDN group.

However, current techniques support MAC rotation (e.g., MAC addresses updated/changed periodically for privacy reasons), such that utilizing MAC addresses for group member identity becomes difficult and may require an end user to identify and re-register and/or add the device to a UDN group each time the MAC addresses are rotated. Moreover, having the end user create a list of device identities that may access the UDN group at the time of the UDN group's creation and manually updating the list (e.g., by registering and/or adding a device) each time a new device tries to access the UDN group, results in the UDN group being static, such that switching a device between two UDN groups is difficult.

Accordingly, there is a need to simplify and streamline UDN configuration and provide a dynamic technique to enable end users to switch between UDN groups without relying on user-initiated registration or requiring link-layer identifiers.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagrams of an environment in which UDN service authorization based on secondary identity credentials is supported.

FIGS. 2A-2C illustrate a flow diagram of example communications corresponding to an end user device initiating a secondary EAP dialogue using secondary credentials in order to access a UDN group.

FIGS. 3A-3C illustrate a flow diagram of example communications corresponding to a controller initiating a secondary EAP dialogue with a user device in order to enable the user device to access a UDN group.

FIG. 4 illustrates a flow diagram of an example method for a system to perform UDN service authorization based on secondary identity credentials.

FIG. 5 illustrates a flow diagram of an example method for a device to perform UDN service authorization based on secondary identity credentials.

FIG. 6 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

The present disclosure relates generally to techniques for performing UDN service authorization based on secondary identity credentials.

A method to perform techniques described herein, where the method may include receiving a first request to connect to the wireless network from a device of a user, the first request including first credentials; authenticating the first credentials; granting access to wireless network to the device; receiving, from the device, a second request to connect to a first user defined network (UDN) group within the wireless network, the second request including second credentials associated with the first UDN group; establishing, in response to the second request, a secondary EAP dialogue with the device; authenticating the second credentials associated with the first UDN group; granting access to the first UDN group to the device; and storing an indication that the device is associated with the first UDN group in a first list associated with the first UDN group.

Another method to perform techniques described herein may include displaying, on a user interface of the device, one or more UDN groups within a wireless network, wherein each of the one or more UDN groups are associated with a respective profile of a user of the device; sending, from the device, a first request to access the wireless network, the first request including first credentials; accessing, by the device, the wireless network; sending, from the device, a second request to access a first UDN group of the one or more UDN groups, wherein the second request comprises second credentials associated with accessing the first UDN group; establishing, with the wireless network, a secondary EAP dialogue; and accessing, by the device, the first UDN group.

Additionally, the techniques described herein may be performed by a system and/or device having non-transitory computer-readable media storing computer-executable instructions that, when executed by one or more processors, performs the method described above.

### Example Embodiments

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

Within the networks, user defined networks (UDNs) may be offered. A UDN is a construct in the enterprise networks for creating logical private groups. The UDN concept is about allowing an end-user to create a private network, which helps in limiting scope for service-discovery, realizing traffic segmentation, and enforcing access controls at the group level.

Currently, users have the ability to create their own UDN in a shared environment. For instance, an end user may manually configure a UDN using an application, self-registering with a cloud service, or through a policy engine. When creating the UDN, the end user registers the identity (e.g., MAC addresses) of the user(s) and devices that may access and/or communicate with the UDN. The cloud service may assign a unique identity to the new UDN group and the unique identifier is then communicated to the infrastructure to enforce segmentation and traffic containment policies within the network. Users and devices may switch between UDN groups through an explicit invite and accept workflow, where the invite and accept workflow is initiated each time a user and/or device access the UDN group and/or tries to switch to a new UDN group.

However, current techniques support MAC rotation (e.g., MAC addresses updated/changed periodically for privacy reasons), such that utilizing MAC addresses for group member identity becomes difficult and may require an end user to identify and re-register and/or add the device to a UDN group each time the MAC addresses are rotated. Moreover, having the end user create a list of device identities that may access the UDN group at the time of the UDN group's creation and manually updating the list (e.g., by registering and/or adding a device) each time a new device tries to access the UDN group, results in the UDN group being static, such that switching a device between two UDN groups is difficult.

Accordingly, there is a need to simplify and streamline UDN configuration and provide a dynamic technique to enable end users to switch between UDN groups without relying on user-initiated registrations or requiring link-layer identifiers.

This disclosure describes techniques and mechanisms for performing UDN service authorization based on secondary identity credentials within a wireless network. For instance, the techniques may include receiving, from a user device, a first request to access a wireless network (e.g., such as a WLAN), where the first request may include primary access credentials. Once primary access authentication of the user device is complete, the techniques may include receiving a second request to access a UDN group within the wireless network. The second request can include secondary credentials for accessing the UDN group. In response to the second request, a secondary EAP dialogue may be established to authenticate the user device using the secondary credentials. Once the secondary credentials are authenticated, the techniques may include granting the user device access to the UDN group.

Additionally, the techniques may comprise displaying, on a user interface of the device, one or more UDN groups within a wireless network, wherein each of the one or more UDN groups are associated with a respective profile of a user of the device; sending, from the device, a first request to access the wireless network, the first request including first credentials; accessing, by the device, the wireless network; sending, from the device, a second request to access a first UDN group of the one or more UDN groups, wherein the second request comprises second credentials associated with accessing the first UDN group; establishing, with the wireless network, a secondary EAP dialogue; and accessing, by the device, the first UDN group.

In some examples, the one or more UDN groups are associated with profiles of the user of the device. For instance, as described in greater detail below, a user of a user device may be associated with one or more UDN profiles. Each UDN profile may corresponds to a separate UDN group within the wireless network. Each UDN group and/or profile may have the same SSID and primary credentials, but may have different secondary identifiers and/or credentials specific to the UDN group.

In some examples, a user device may send a request to access a network and/or UDN group in response to receiving a selection of a UDN profile. As described in greater detail below, the network may perform primary access authentication of the user device using primary credentials. The user device may then send a request to the network to access a first UDN group associated with the UDN profile. The network may then perform secondary authentication of the user device (e.g., such as via an EAP dialogue) using secondary credentials associated with the UDN group.

As described in greater detail below, a user may select a second UDN profile in order to access a second UDN group. In this example, the user device sends a request to the network that includes the secondary credentials associated with the UDN group and the network may perform secondary authentication of the user device.

In this way, an end user may access a UDN group using secondary authentication that is exclusive to the UDN group. Accordingly, UDN service authorization is streamlined by eliminating the need to manually configure a user each time the user accesses a UDN group. Moreover, when a user switches between UDN groups, the user device is only required to perform secondary authentication for the UDN group (and not primary access authentication for the Wi-Fi network), thereby simplifying the UDN workflow and enabling dynamic UDN groups. Additionally, by providing multiple SSID profiles for the same SSID, with secondary identities specific to UDN groups, the current techniques eliminate the need to rely on MAC addresses as device identifiers.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

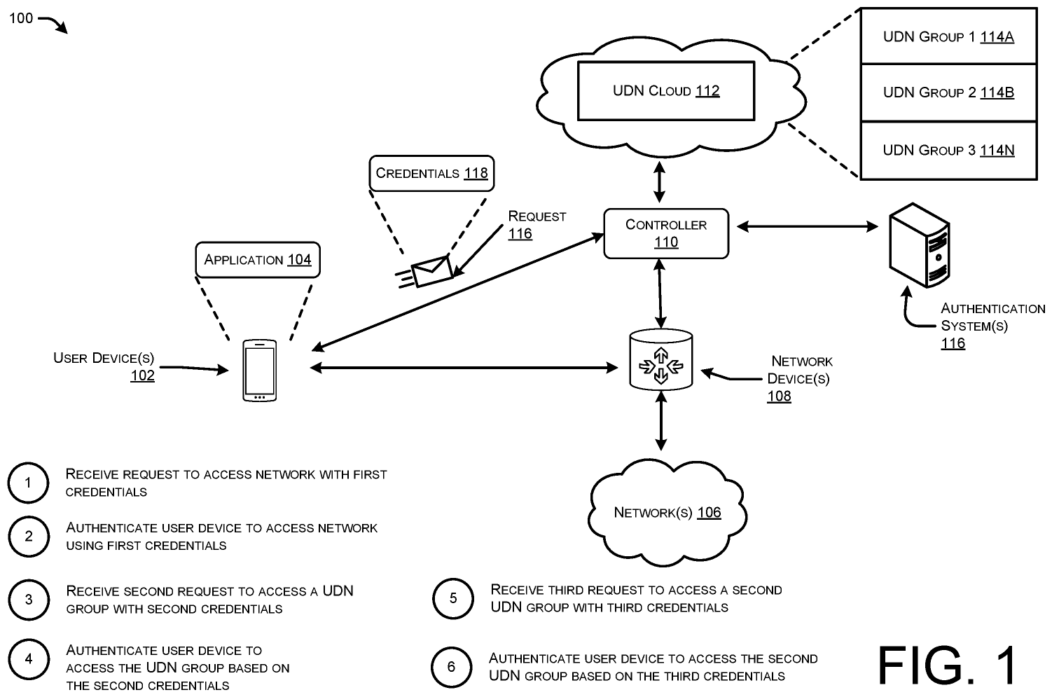

FIG. 1 illustrates a system-architecture diagrams of an environment 100 in which UDN service authorization based on secondary identity credentials is supported. In some examples, the environment 100 may include a user device 102. The user device 102 may include any computing device, such as a mobile device, a laptop, a computer, a tablet, or any Wi-Fi enabled device and/or any Bluetooth enabled device. In some examples, the user device 102 may correspond to a device of an administrator (not shown). In some examples, the user device 102 may correspond to a device of an end user. The user device 102 may include an application 104. The application 104 may correspond to a UDN application that enables a user of the user device 102 to access network(s) 106, create UDN network(s), etc.

In some examples, the user device 102 may communicate with one or more of a controller 110 and/or network device 108 in order to access network(s) 106. Networks 106 may include any combination of Personal Area Networks (PANs), Local Area Networks (LANs), Campus Area Networks (CANS), Metropolitan Area Networks (MANs), extranets, intranets, the Internet, Wide Area Networks (WANs)—both centralized and/or distributed—and/or any combination, permutation, and/or aggregation thereof. The user device(s) 102 and/or network device(s) 108 may communicate using any type of protocol over the network(s) 106, such as the transmission control protocol/Internet protocol (TCP/IP) that is used to govern connects to and over the Internet.

In some examples, the network(s) 106 may corresponds to a service network that includes devices housed or located in one or more data centers. The service network may include one or more networks implemented by any viable communication technology, such as wired and/or wireless modalities and/or technologies. The service network may include any combination of Personal Area Networks (PANS), Local Area Networks (LANs), Wireless LANs, Campus Area Networks (LANs), Metropolitan Area Networks (MANS), extranets, intranets, the Internet, short-range wireless communication networks (e.g., ZigBee, Bluetooth, etc.), Wide Area Networks (WANs)—both centralized and/or distributed—and/or any combination, permutation, and/or aggregation thereof. The service network may include devices, virtual resources, or other nodes that relay packets from one network segment to another by nodes in the computer network. The service network may include multiple devices that utilize the network layer (and/or session layer, transport layer, etc.) in the OSI model for packet forwarding, and/or other layers.

The one or more data centers may be physical facilities or buildings located across geographic areas that designated to store networked devices that are part of manufacturer 102. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the packet-forwarding networks may not be located in explicitly defined data centers, but may be located in other locations or buildings.

In some examples, network device(s) 108 correspond to any computing device, routers, switches, computers, or any other type of network device. In some examples, the network device(s) 108 may comprise an access point. For instance, as illustrated in FIG. 1, the user device 102 may be connected to the network(s) 106 via an access point 108.

In some examples, the controller 110 may comprise a computing device, processor(s), memory, etc. For instance, the controller 110 may correspond to a Cisco 105 based Catalyst Series physical wireless LAN controller (WLC) or a virtual WLC. In some examples, the controller 110 may be included as part of one or more of the network device 108, authentication system 116, and/or UDN cloud 112.

In some examples, the controller 110 may be connected to and/or communicate with one or more authentication system(s) 116. In some examples, the authentication system 116 may include any website, database, server(s), computing device(s), or other service. The controller 110 may connect and/or access the authentication system 116 to initiate primary authentication and/or secondary authentication of the user device (e.g., such as via an EAP dialogue). In some examples, the authentication system 116 corresponds to one or more authentication, accounting, and authorization (AAA) engines. In some examples, the authentication system(s) 116 may correspond to an AAA engine and/or a third-party authentication service. In some examples, the authentication system 116 may be included as part of the network device 108 and/or the UDN cloud 112.

In some examples, the controller 110 may communicate with the UDN cloud 112 directly and/or indirectly. The UDN cloud 112 may comprise one or more UDN group(s) 114 within the network 106. For instance, the UDN cloud 112 may correspond to Cisco UDN Cloud.

As illustrated in FIG. 1, the user device 102 may communicate (e.g., send a request 116) with the network device 108 and/or controller 110 in order to access the network(s) 106 and/or UDN group(s) 114. In some examples, the request 116 may comprise credentials 118 (e.g., username, password, group identifier(s), etc.).

At “1”, the controller 110 and/or network device 108 may receive a request to access a network, where the request includes first credentials. In some examples, the network 106 may correspond to a Wi-Fi network available on a school campus. In this example, the request 116 may comprise first credentials associated with accessing the Wi-Fi network. In some examples, the request 116 is sent in response to user input into a user device 102 and/or application 104. For instance, as described in greater detail below, the application may display profile(s) associated with the user, where each profile has a same primary identifier (e.g., SSID) associated with the network 106, but different secondary identifiers that are specific to the UDN group(s) 114). In some examples, such as where the network 106 is associated with a school, a first UDN group 114A may be associated with a first class and/or classroom and a second UDN group 114B may be associated with a second class and/or classroom.

As an example, where the network is named “Blizzard”, the application and/or user device 102 may display two profiles associated with the user and UDN group(s): (1) Blizzard-Group1. (SSID=blizzard, primary identity=Joe, secondary identity=UDN-Group-1); and (2) Blizzard-Group2 (SSID===blizzard, primary identity=Joe, secondary identity=UDN-Group-2). In this example, the user may select the first profile associated with a first UDN group (e.g., “Blizzard-Group1”) and the request to access the network 106 may be sent to network device 108 and/or controller 110.

At “2”, the controller 110 and/or network device 108 may authenticate the user device to access the network using the first credentials. For instance, the controller. 110 may perform access authentication using the first credentials associated with the Wi-Fi network. In some examples, the controller 110 may communicate with the authentication system 116 to authenticate the user device 102. For instance, where the first credentials comprise a username and password, the controller 110 may communicate with an authentication system to determine whether the username and password match those stored in a database. Once primary access authentication is complete, the user device 102 may access the Wi-Fi network.

At “3”, the controller 110 and/or network device 108 may receive a second request to access a UDN group, where the second request includes second credentials. In some examples, the second request is sent automatically and without additional user input. For instance, the second request may be sent in response to the user device accessing the Wi-Fi network. For instance, where the first request is sent in response to a user selecting a first profile associated with a first UDN group, the second request may be sent in response to primary access authentication being completed. The second request may comprise second credentials. The second credentials may be associated with the UDN group. For instance, the second credentials may comprise a group identifier of the UDN group, a password associated with the UDN group, or any other credential. In some examples, the second request may comprise an EAP identity/request message that includes the second credentials.

At “4”, the controller 110 and/or network device 108 may authenticate the user device to access the UDN group based on the second credentials. For instance, as described in greater detail below, the controller 110 may establish a secondary EAP dialogue with the user device in order to authenticate the second credentials. Once authenticated the controller 110 may add the user device to the UDN group, such that the user device has access to the UDN group (e.g., Blizzard-Group1).

At “5”, the controller. 110 and/or network device 108 may receive a third request to access a second UDN group, the third request including third credentials. In some examples, the third request may be associated with a user selecting a second profile (e.g., Blizzard-Group2). For instance, where the network is associated with a school, the user may select the second profile in response to changing classes and/or classrooms.

At “6”, the controller 110 and/or network device 108 may authenticate the user device to access the second group based on the third credentials. For instance, the user device may initiate another EAP dialogue with the controller 110 in order to access the second UDN group. In some examples, the identity that is used for this EAP dialogue is the group identifier of the second UDN group (e.g., UDN-Group-2). Once authenticated, the controller. 11.0 may grant access to the second UDN group to the user device, add the user device to the second UDN group, and remove the user device from the first UDN group. In some examples, the controller 110 may authenticate and grant the user device 102 access to the second UDN group for a period of time (e.g., such as the duration of a class period, 2 hours, 3 hours, or any other suitable time period).

In this way, UDN service authorization is streamlined by enabling a user device to automatically initiate a secondary EAP dialogue to access a UDN group in response to a successful primary access authentication. Moreover, by performing secondary EAP dialogue (e.g., secondary authentication) of a user device when switching between UDN groups (and not primary access authentication for the Wi-Fi network), thereby simplifying the UDN workflow and enabling dynamic UDN groups.

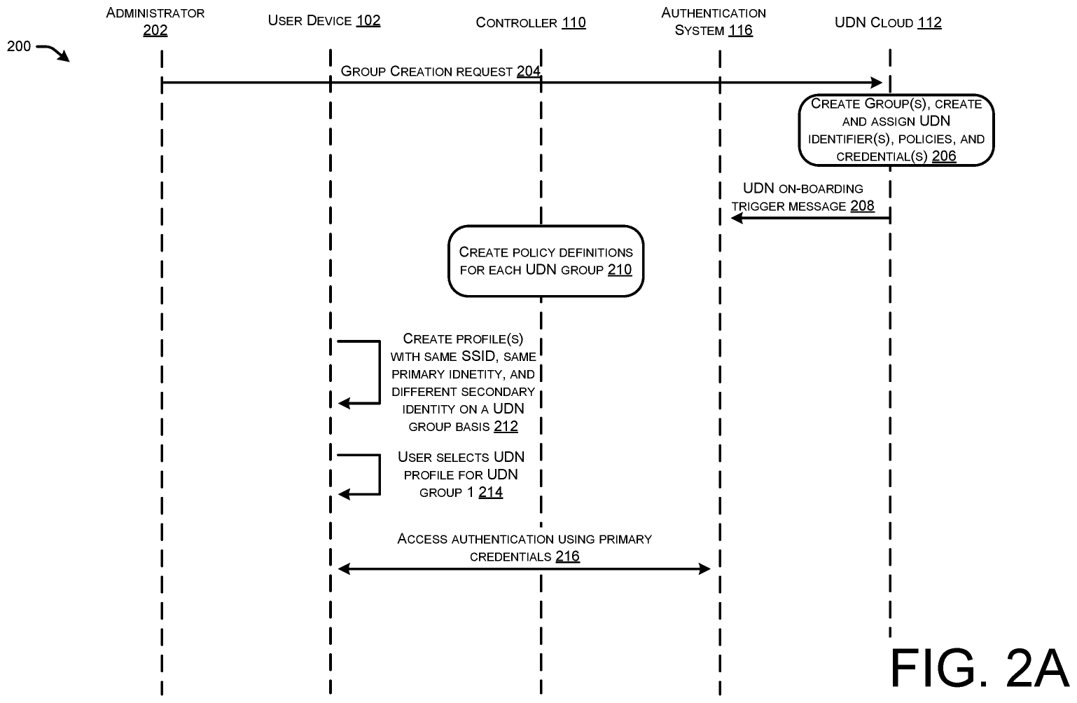

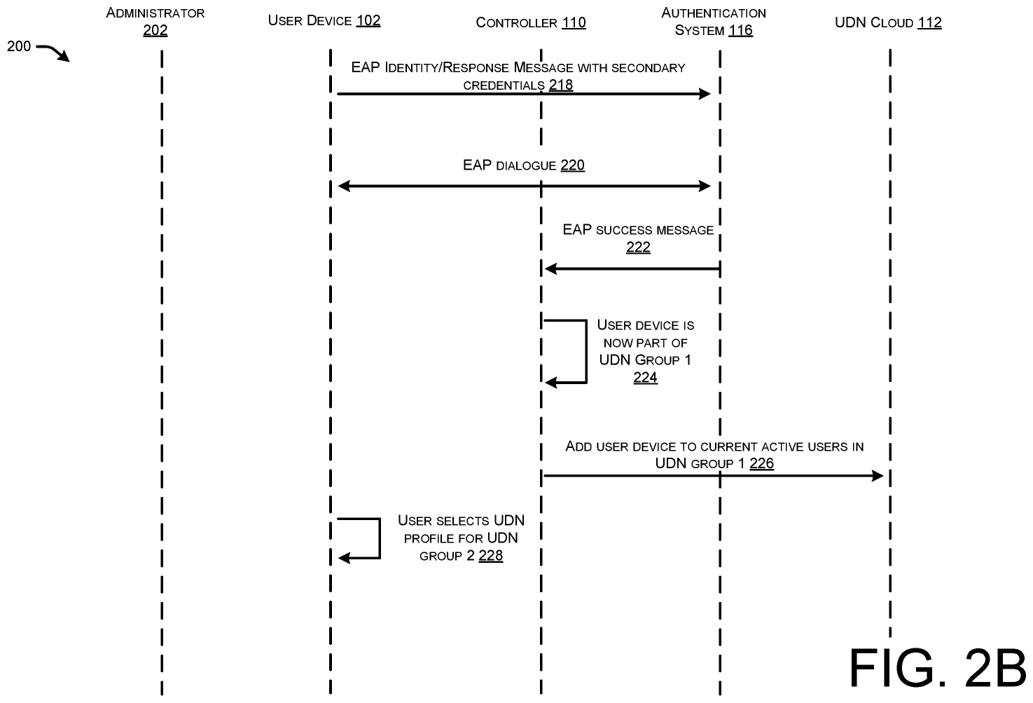

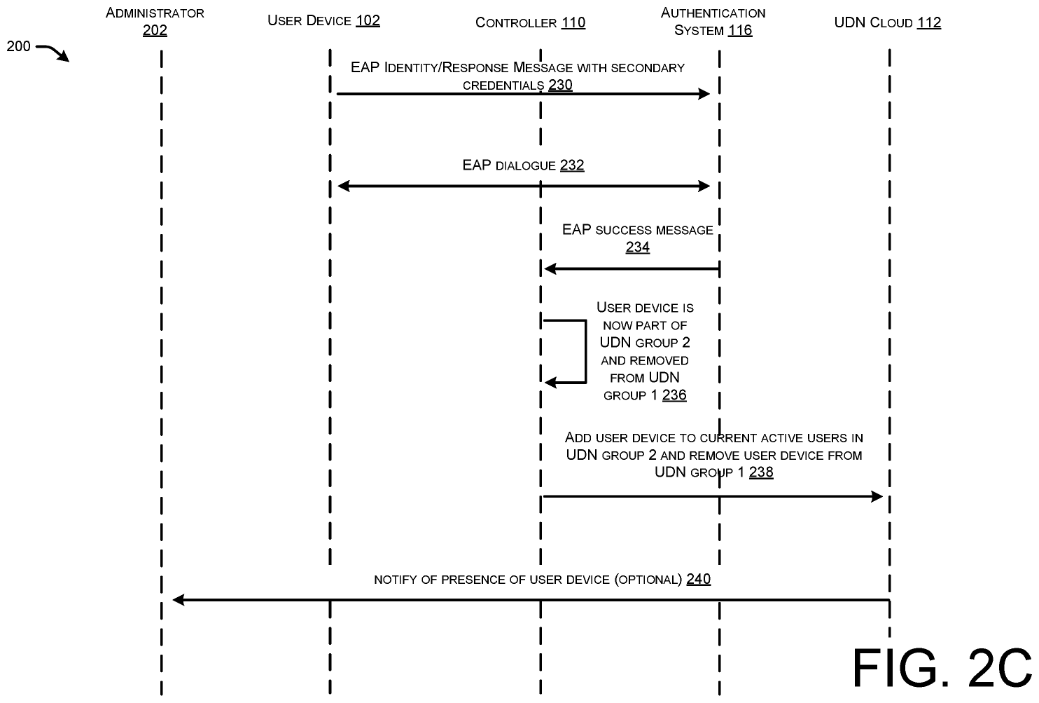

FIGS. 2A-2C illustrates a flow diagram 200 of example communications corresponding to an end user device initiating a secondary EAP dialogue using secondary credentials in order to access a UDN group. For instance, the end user device may correspond to user device 102 described above. In some examples, the user of the user device may correspond to a student attempting to access a wireless network associated with a school. In this example, the UDN groups may be associated with classes and/or classrooms.

As illustrated in FIG. 2A, at 204, an administrator 202 may send a room creation request to the UDN cloud 112. In some examples, the administrator 202 (e.g., school administrator, network administrator, etc.) may access a portal via a computing device and/or user device (e.g., such as via application 104, or another application) in order to create UDN groups within a network 106 of the school. In some examples, the administrator 202 may configure the UDN group(s) to be accessible for specific periods of time. For instance, where a first UDN group corresponds to a class, the first UDN group may be accessible to users for a set period of time, such as the duration of the class period or any other suitable time period.

At 206, the UDN cloud 112 may create the UDN group(s), create and assign UDN group identifier(s), create and assign policies to the UDN group(s), and create and assigned UDN group credential(s). For instance, each UDN group may be associated with a group identifier and/or a group credential (e.g., password, etc.). In some examples, the administrator 202 may identify user(s) associated with each UDN group. For instance, where a UDN group is associated with a class, the administrator may add student(s) to the UDN group. In some examples, each user may be assigned a different credential in order to access the UDN group. In other examples, each user may utilize the same credential associated with the UDN group in order to access the UDN group.

In some examples, the group credentials for accessing each UDN group may be shared with users of each respective UDN group via any out of band approaches (e.g., in person, USB, or any other suitable method of sharing information).

At 208, the UDN cloud 112 may send a UDN on-boarding trigger message to the authentication system 116. For instance, the UDN cloud may push the on-boarding trigger message to the authentication system 116, wherein the on-boarding trigger message comprises one or more identities of end user device(s) and/or UDN identifier(s).

At 210, the controller 110 may create and store policy definitions for each UDN group created at 206. For instance, the controller 110 may store the policy definitions (e.g., such as security policies for accessing the UDN group(s)) in memory.

At 212, the user device 102 may create profile(s) that have the same SSID, same primary identity, and different secondary identity on a UDN group basis. For instance, as noted above, where a network is named “Blizzard” and the user of the user device is associated with two UDN groups, the user device may create and display two profiles: (1) Blizzard-Group/(SSID=blizzard, primary identity=Joe, secondary identity=UDN-Group-1); and (2) Blizzard-Group2 (SSID=blizzard, primary identity=Joe, secondary identity=UDN-Group-2). In this example, the SSID (e.g., “blizzard”) is the same for both UDN groups, the primary identity (e.g., “Joe”) is the same for both groups, and the secondary identity (e.g., “UDN-Group-1” and “UDN-Group-2”) are different for each UDN group. In addition, each UDN group will be associated with secondary credentials that are different from the primary credentials associated with accessing the network.

At 214, the user device 102 may receive input from a user that indicates a selection of a UDN profile associated with a first UDN group. For instance, the input may indicate a user's selection of the first profile (e.g., Blizzard-Group1) associated with UDN-Group-1.

At 216, the user device 102 may establish a connection with the authentication system 116 and perform access authentication using the primary credentials. For instance, as described above, in response to the user selection of the first profile, the user device may send a request (e.g., such as an EAP identity/request message that includes the primary credentials for accessing the network) to the controller 110 and/or authentication system 116. The user device and authentication system may establish a primary EAP dialogue, using the primary credentials associated with accessing the network (e.g., “blizzard”). Once primary access authentication is completed successfully, the user device 102 may access the network (e.g., “blizzard”). In some examples, the network may comprise a WLAN.

At 218, the user device 102 may send an EAP identity/response message to the authentication system 116. In some examples, the EAP identity/response message may include secondary credentials associated with accessing the selected UDN group (e.g., UDN-Group-1). In some examples, the identity used in the EAP identity/response message is the group identity of the selected UDN group. In this example, the group identity is “UDN-Group-1.” In some examples, the EAP identity/response message may additionally include one or more of the UDN group name, UDN group identifier, and/or any other suitable information.

As noted above, in some examples, the authentication system 116 may correspond to an external entity that manages only secondary credentials and/or secondary authentication of the user device. For instance, a first authentication system 116 (e.g., such as an AAA engine) may handle primary access authentication of the user device at 216 and a second authentication system 116 (e.g., such as an external entity), may handle the secondary authentication associated with the UDN group(s).

At 220, the user device 102 and the authentication system 116 establish an EAP dialogue. For instance, the EAP dialogue may comprise a secondary EAP dialogue for completing secondary authentication to access the selected UDN group (e.g., UDN-Group-1).

At 222, the authentication system 116 sends the controller 110 an EAP success message indicating successful authentication of the user device. Where authentication of the user device is unsuccessful, the authentication system 116 may send the controller 110 an EAP unsuccessful message and the controller 110 may deny the user device access to the UDN group. In this example, the user device 102 is still connected to the network (e.g., the WLAN), but may not access the UDN group.

At 224, the controller 110 stores an indication that the user device is now part of UDN-Group-1. In some examples, the controller 110 may grant access to the UDN group to the user device. In some examples, the controller 110 may grant access to the UDN group for a specific period of time. For instance, where a first UDN group corresponds to a class, the UDN-Group-1 may be accessible to the user device 102 for a set period of time, such as the duration of the class period or any other suitable time period. In some examples, the controller 110 may apply the policies created and stored at 210 in order to allow the user device to be included in the private network created for UDN-Group-1.

At 226, the controller 110 sends a message to the UDN cloud 112. In some examples, the message includes instructions for the UDN cloud to add the user device to a current active user in UDN-Group-1. In some examples, the UDN cloud 112 adds the user device to an active list, table, or memory.

At 228, the user may select a second UDN profile for accessing a second UDN group. For instance, the user device may receive second input indicating a selection of Blizzard-Group2. In some examples, the user may select a second profile in response to switching classes (e.g., class 1/UDN-Group-1 to class 2/UDN-Group-2).

At 230, in response to receiving the second input indicating the selection of a second UDN profile, the user device may send an EAP identity/response message to the authentication system 116, where the EAP identity/response message includes secondary credentials associated with the second UDN group. In some examples, the identity used in the EAP identity/response message is the group identity of the selected UDN group. In this example, the group identity is “UDN-Group-2.” In some examples, the EAP identity/response message may additionally include one or more of the UDN group name, UDN group identifier, and/or any other suitable information.

At 232, the user device 102 and authentication system 116 establish an EAP dialogue. As noted above, the EAP dialogue may be a secondary EAP dialogue for authenticating the user device to access the second UDN group.

At 234, the authentication system 116 sends the controller 110 an EAP success message. Where authentication of the user device is unsuccessful, the authentication system 116 may send the controller 110 an EAP unsuccessful message and the controller 110 may deny the user device access to the UDN group. In this example, the user device 102 is still connected to the network (e.g., the WLAN), but may not access the UDN group.

At 236, the controller 110 stores an indication that the user device is now part of UDN-Group-2 and removes the user device from UDN-Group-1. In some examples, the controller 110 may grant access to UDN-Group-2 to the user device. In some examples, the controller 110 may grant access to the second UDN group for a specific period of time. For instance, UDN-Group-2 may be accessible to the user device 102 for a set period of time, such as the duration of the class period or any other suitable time period. In some examples, the controller 110 may apply the policies created and stored at 210 in order to allow the user device to be included in the private network created for UDN-Group-2.

At 238, the controller 110 sends a message to the UDN cloud 112. In some examples, the message includes instructions for the UDN cloud to add the user device to a current active user in UDN-Group-2. In some examples, the UDN cloud 112 adds the user device to an active list, table, or memory. The message may also include instructions for the MN cloud to remove the user device from the current active users in UDN-Group-1.

At 240, the UDN cloud may, optionally, notify the administrator of the presence of the user device 102 in one or more of the UDN groups.

Accordingly, by simply selecting a UDN profile, a user can switch from a first UDN group to a second UDN group with only secondary credentials being verified, thereby streamlining UDN service authorization.

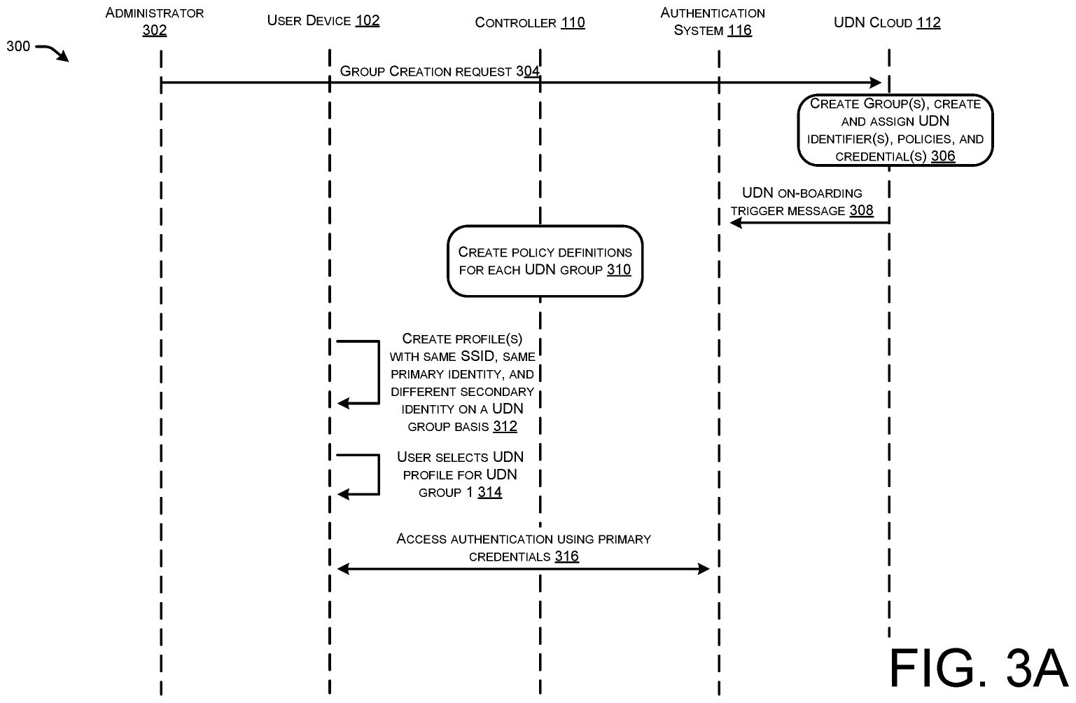

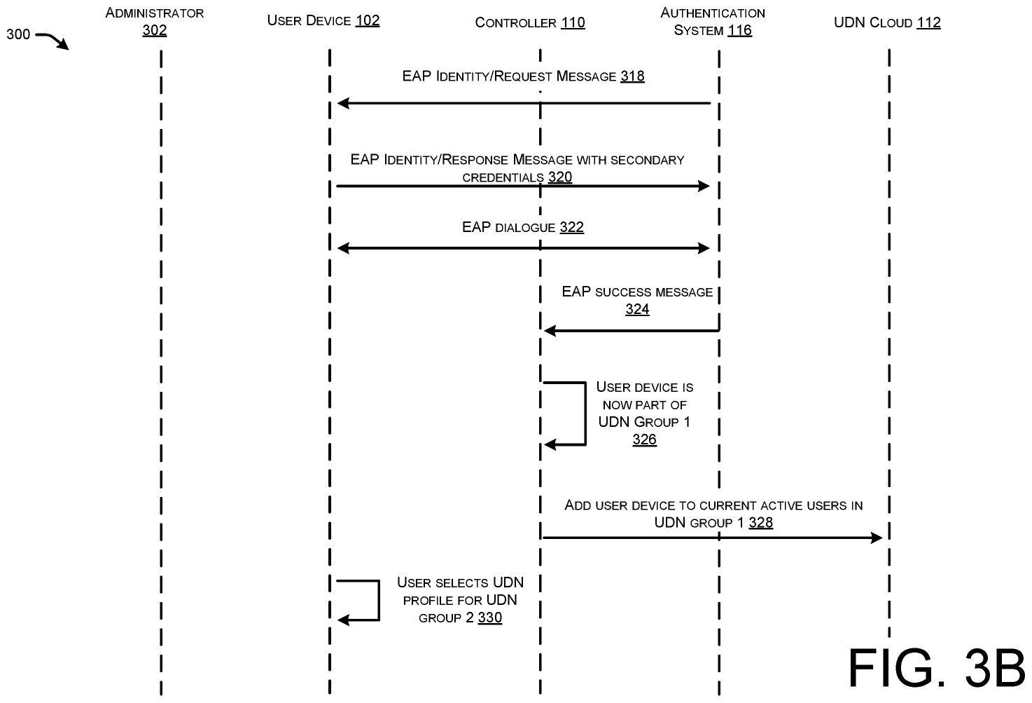

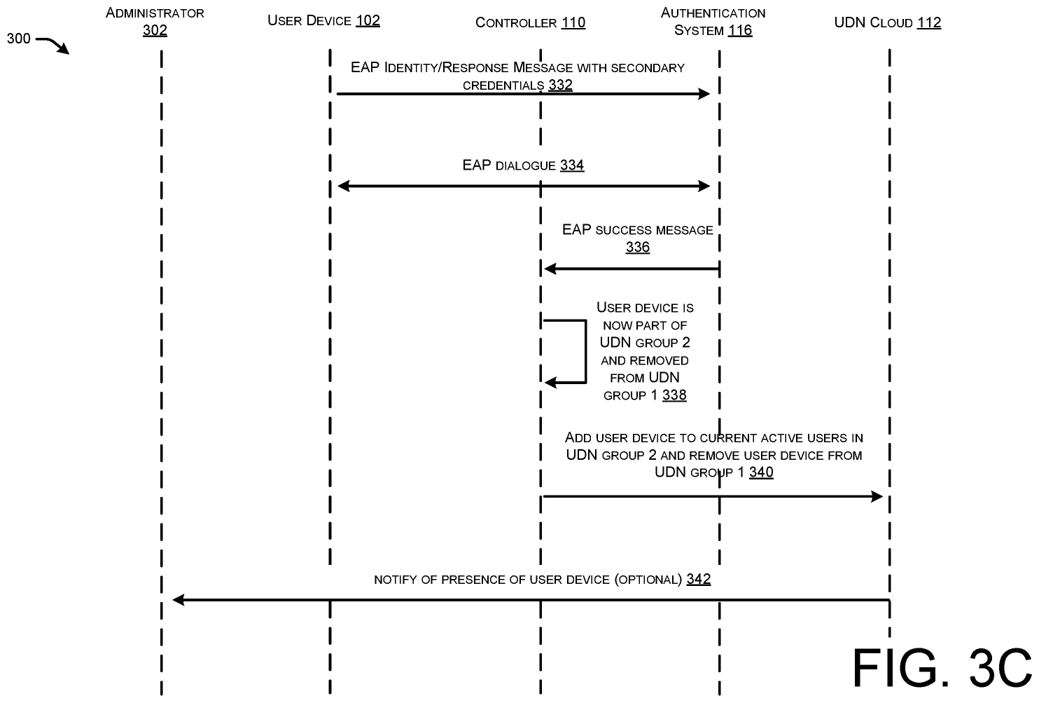

FIGS. 3A-3C illustrate a flow diagram 300 of example communications corresponding to a controller initiating a secondary EAP dialogue with a user device in order to enable the user device to access a UDN group. For instance, the controller may correspond to controller 110 described above. The user device may correspond to user device 102 described above. In some examples, the user of the user device may correspond to a student attempting to access a wireless network (e.g., such as a WLAN) associated with a school. In this example, the UDN groups may be associated with classes and/or classrooms.

As illustrated in FIG. 3A, at 304, an administrator 302 may send a room creation request to the UDN cloud 112. In some examples, the administrator 302 (e.g., school administrator, network administrator, etc.) may access a portal via a computing device and/or user device (e.g., such as via application 104, or another application) in order to create UDN groups within a network 106 of the school, in some examples, the administrator 302 may configure the UDN group(s) to be accessible for specific periods of time. For instance, where a first UDN group corresponds to a class, the first UM group may be accessible to users for a set period of time, such as the duration of the class period or any other suitable time period.

At 306, the UDN cloud 112 may create the UDN group(s), create and assign UDN group identifier(s), create and assign policies to the UDN group(s), and create and assigned UDN group credential(s). For instance, each UDN group may be associated with a group identifier and/or a group credential (e.g., password, etc.). In some examples, the administrator 302 may identify user(s) associated with each UDN group. For instance, where a UDN group is associated with a class, the administrator may add student(s) to the UDN group. In some examples, each user may be assigned a different credential in order to access the UDN group. In other examples, each user may utilize the same credential associated with the UDN group in order to access the UDN group.

In some examples, the group credentials for accessing each UDN group may be shared with users of each respective UDN group via any out of band approaches (e.g., in person, USB, or any other suitable method of sharing information).

At 308, the UDN cloud 112 may send a UDN on-boarding trigger message to the authentication system 116. For instance, the UDN cloud may push the on-boarding trigger message to the authentication system 116, wherein the on-boarding trigger message comprises one or more identities of end user device(s) and/or UDN identifier(s).

At 310, the controller 110 may create and store policy definitions for each UDN group created at 306. For instance, the controller 110 may store the policy definitions (e.g., such as security policies for accessing the UDN group(s)) in memory.

At 312, the user device 102 may create profile(s) that have the same SSID, same primary identity, and different secondary identity on a UDN group basis. For instance, as noted above, where a network is named “Blizzard” and the user of the user device is associated with two UDN groups, the user device may create and display two profiles: (1) Blizzard-Group1 (SSID=blizzard, primary identity=Joe, secondary identity=UDN-Group-1); and (2) Blizzard-Group2 (SSID=blizzard, primary identity=Joe, secondary identity=UDN-Group-2). In this example, the SSID (e.g., “blizzard”) is the same for both UDN groups, the primary identity (e.g., “Joe”) is the same for both groups, and the secondary identity (e.g., “UDN-Group-1” and “UDN-Group-2”) are different for each UDN group. In addition, each UDN group will be associated with secondary credentials that are different from the primary credentials associated with accessing the network.

At 314, the user device 102 may receive input from a user that indicates a selection of a UDN profile associated with a first UDN group. For instance, the input may indicate a user's selection of the first profile (e.g., Blizzard-Group1) associated with UDN-Group-1.

At 316, the user device 102 may establish a connection with the authentication system 116 and perform access authentication using the primary credentials. For instance, as described above, in response to the user selection of the first profile, the user device may send a request (e.g., such as an EAP identity/request message that includes the primary credentials for accessing the network) to the controller 110 and/or authentication system 116. The user device and authentication system may establish a primary EAP dialogue, using the primary credentials associated with accessing the network (e.g., “blizzard”). Once primary access authentication is completed successfully, the user device 102 may access the network (e.g., “blizzard”). In some examples, the network may comprise a WLAN.

At 318, the authentication system 116 may send an EAP identity/request message to the user device 102. For instance, the authentication system 116 may, in response to successfully authenticating access to the network, identify the user device as being included in one or more UDN groups. In response, the authentication system 116 may send an EAP identity/request message to the user device, to see if the user wants to access one or more UDN profile(s). In some examples, the EAP identity request message may include a UDN group identifier associated with the UDN group (e.g., such as the first UDN group associated with the first profile selected by the user).

At 320, the user device 102 may send an EAP identity/response message to the authentication system 116. In some examples, the EAP identity/response message may include secondary credentials associated with accessing the selected UDN group (e.g., UDN-Group-1). In some examples, the identity used in the EAP identity/response message is the group identity of the selected UDN group. In this example, the group identity is “UDN-Group-1.” In some examples, the EAP identity/response message may additionally include one or more of the UDN group name, UDN group identifier, and/or any other suitable information.

As noted above, in some examples, the authentication system 116 may correspond to multiple authentication systems. For instance, a first authentication system 116 (e.g., such as an AAA engine) may handle primary access authentication of the user device at 316 and a second authentication system 116 (e.g., such as an external entity), may handle the secondary authentication associated with the UDN group(s).

At 322, the user device 102 and the authentication system 116 establish an EAP dialogue. For instance, the EAP dialogue may comprise a secondary EAP dialogue for completing secondary authentication to access the selected UDN group (e.g., UDN-Group-1).

At 324, the authentication system 116 sends the controller 110 an EAP success message indicating successful authentication of the user device. Where authentication of the user device is unsuccessful, the authentication system 116 may send the controller 110 an EAP unsuccessful message and the controller 110 may deny the user device access to the UDN group. In this example, the user device 102 is still connected to the network (e.g., the WLAN), but may not access the UDN group.

At 326, the controller 110 stores an indication that the user device is now part of UDN-Group-1. In some examples, the controller 110 may grant access to the UDN group to the user device. In some examples, the controller 110 may grant access to the UDN group for a specific period of time. For instance, where a first UDN group corresponds to a class, the UDN-Group-1 may be accessible to the user device 102 for a set period of time, such as the duration of the class period or any other suitable time period. In some examples, the controller 110 may apply the policies created and stored at 310 in order to allow the user device to be included in the private network created for UDN-Group-1.

At 328, the controller 110 sends a message to the UDN cloud 112. In some examples, the message includes instructions for the UDN cloud to add the user device to a current active user in UDN-Group-1. In some examples, the UDN cloud 112 adds the user device to an active list, table, or memory.

At 330, the user may select a second UDN profile for accessing a second UDN group. For instance, the user device may receive second input indicating a selection of Blizzard-Group2. In some examples, the user may select a second profile in response to switching classes (e.g., class 1/UDN-Group-1 to class 2/UDN-Group-2).

At 332, in response to receiving the second input indicating the selection of a second UDN profile, the user device may send an EAP identity/response message to the authentication system 116, where the EAP identity/response message includes secondary credentials associated with the second UDN group. In some examples, the identity used in the EAP identity/response message is the group identity of the selected UDN group. In this example, the group identity is “UDN-Group-2.” In some examples, the EAP identity/response message may additionally include one or more of the UDN group name, UDN group identifier, and/or any other suitable information.

At 334, the user device 102 and authentication system 116 establish an EAP dialogue. As noted above, the EAP dialogue may be a secondary EAP dialogue for authenticating the user device to access the second UDN group.

At 336, the authentication system 116 sends the controller 110 an EAP success message. Where authentication of the user device is unsuccessful, the authentication system 116 may send the controller 110 an EAP unsuccessful message and the controller 110 may deny the user device access to the UDN group. In this example, the user device 102 is still connected to the network (e.g., the WLAN), but may not access the UDN group.

At 338, the controller 110 stores an indication that the user device is now part of UDN-Group-2 and removes the user device from UDN-Group-1. In some examples, the controller 110 may grant access to UDN-Group-2 to the user device. In some examples, the controller 110 may grant access to the second UDN group for a specific period of time. For instance, UDN-Group-2 may be accessible to the user device 102 for a set period of time, such as the duration of the class period or any other suitable time period. In some examples, the controller 110 may apply the policies created and stored at 310 in order to allow the user device to be included in the private network created for UDN-Group-2.

At 340, the controller 110 sends a message to the UDN cloud 112. In some examples, the message includes instructions for the UDN cloud to add the user device to a current active user in UDN-Group-2. In some examples, the UDN cloud 112 adds the user device to an active list, table, or memory. The message may also include instructions for the UDN cloud to remove the user device from the current active users in UDN-Group-1.

At 342, the UDN cloud may, optionally, notify the administrator of the presence of the user device 102 in one or more of the UDN groups.

Accordingly, by simply selecting a UDN profile, a user can switch from a first UDN group to a second UDN group with only secondary credentials being verified, thereby streamlining UDN service authorization.

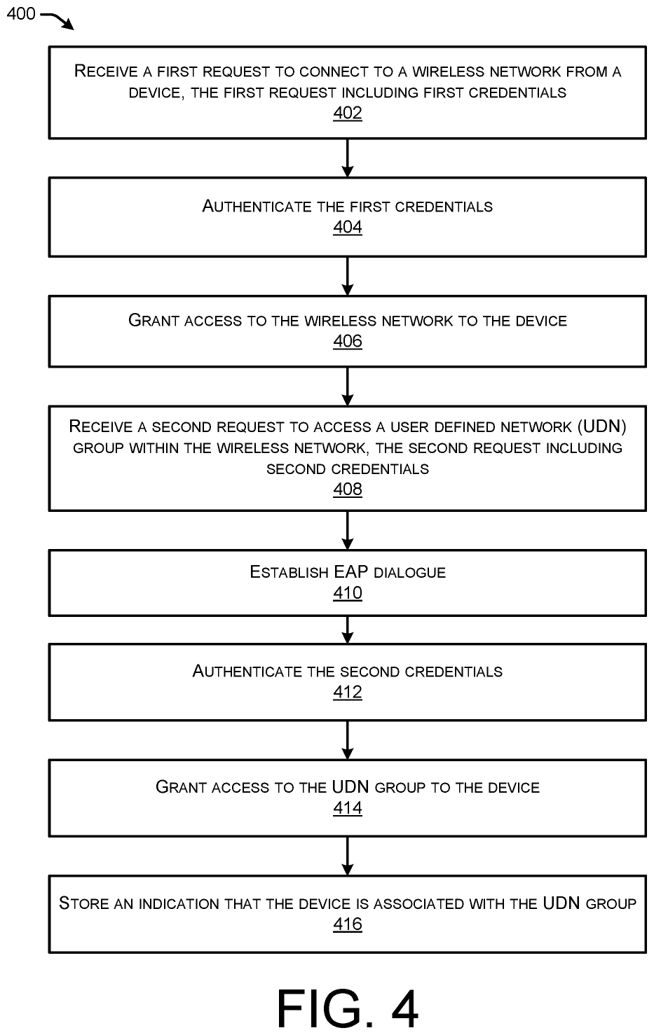

FIG. 4 illustrates a flow diagram of an example method 400 for a system to perform UDN service authorization based on secondary identity credentials. In some instances, the techniques may be performed by a system (e.g., one or more devices), such as the controller 110, network device 108, UDN cloud 112, authentication system(s) 116, a combination thereof, and/or any other devices (e.g., hardware offload chips and/or any other device). The techniques of method 400 may be performed by a system that includes one processor, or more than one processor.

At 402, the system may receive a first request to connect to a network from a device, the first request including first credentials. For instance, the first credentials may comprise primary credentials for accessing a wireless network (e.g., such as a WLAN), as described above.

At 404, the system may authenticate the first credentials. For instance, the system may authenticate the first credentials via an AAA engine or other authentication system as described above.

At 406, the system may grant access to the wireless network to the device.

At 408, the system may receive a second request to access a user defined network (UDN) group within the wireless network, the second request including second credentials. In some examples, the UDN group is associated with a first profile of a user of the device, such as the UDN profiles described above. In some examples, the second credentials may comprise at least one of an identifier associated with the UDN group, a username (e.g., identifier of the user and/or user device), and/or a password associated with the UDN group. In some examples, the second credentials may comprise a decorated network access identifier (NAI) (e.g., where the UDN group identifier is incorporated into the NAI) or other explicit field.

In some examples, the system may receive the second request from the device in response to granting access to the network. In this example, the second request may correspond to an EAP identity/response message, as described above. In other examples, the system may send, to the device, and in response to authenticating the first credentials, a request for secondary credentials associated with the UDN group. As noted above, in this example, the request may comprise an EAP identity/request message. In this example, the system may receive from the device a message (e.g., an EAP identity/response message) including the second credentials and a secondary EAP dialogue may then be established.

At 410, the system may establish an EAP dialogue. For instance, as described above the system may establish an EAP dialogue between the device and the network (e.g., a controller, authentication system, etc.). As noted above, the EAP dialogue may correspond to a secondary EAP dialogue.

At 412, the system may authenticate the second credentials. For instance, the system may authenticate the second credentials via an AAA engine or other authentication service. In some examples, the system may authenticate the second credentials using a third-party authentication system.

At 414, the system may grant access to the UDN group to the device. For instance, the device may be enabled to access the UDN group. As noted above, the system may grant access to the UDN group for a period of time.

At 416, the system may store an indication that the device is associated with the UDN group. As noted above, the system may store one or more dynamic list(s), table(s), etc., in memory to track active users associated with a UDN group.

In some examples, the system may receive, from the device, a third request to connect to a second UDN group within the wireless network, the third request including third credentials associated with the second UDN group. In some examples, the third request may correspond to a user selecting a second UDN profile associated with the second UDN group. The system may establish, in response to the third request, a secondary EAP dialogue with the device and authenticate the third credentials associated with the second UDN group as described above. The system may, in response to authenticating the device, grant access to the second UDN group to the device, update the first list to remove the device from the first UDN group, and store an indication that the device is associated with the second UDN group in a second list associated with the second UDN group.

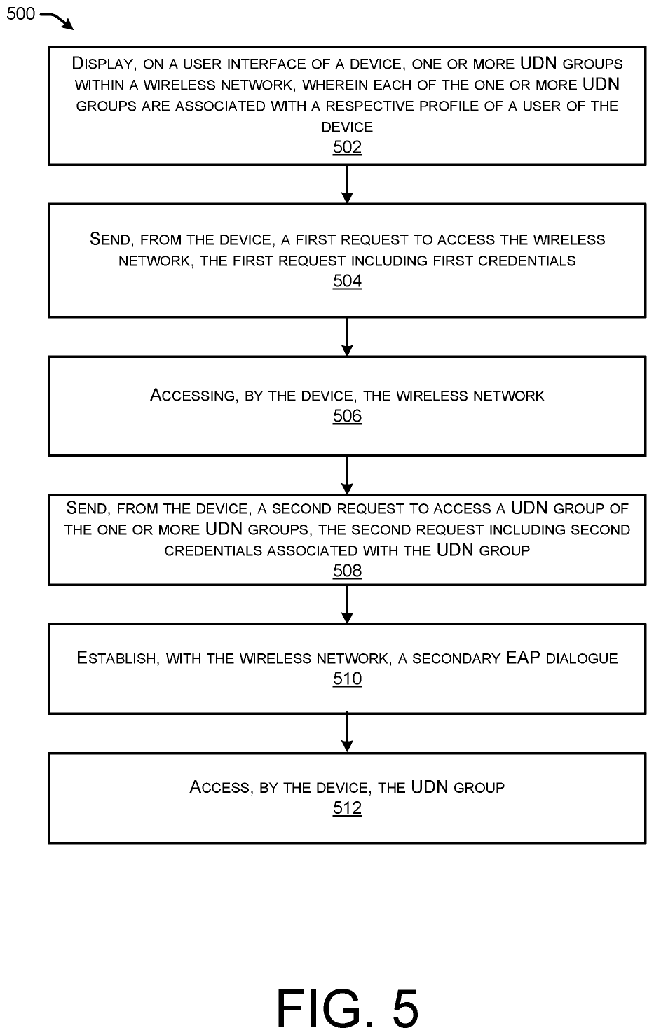

FIG. 5 illustrates a flow diagram of an example method 500 for a device to perform UDN service authorization based on secondary identity credentials. In some instances, the steps of method 500 may be performed by a device (e.g., user device 102) that includes one or more processors and one or more non-transitory computer-readable media storing computer-executable instructions that, when executed by the one or more processors, cause the one or more processors to perform operations of method 500.

At 502, the device may display, on a user interface of the device, one or more UDN groups within a wireless network, wherein each of the one or more UDN groups are associated with a respective profile of a user of the device.

In some examples and, as noted above, the device may create one or more profiles (e.g., UDN profiles) associated with one or more UDN group(s). As noted above, each profile may comprise a same primary identifier (e.g., such as the SSID), and may comprise unique respective secondary identifier(s).

At 504, the device may send, from the device, a first request to access the wireless network, the first request including first credentials. In some examples, the first request is sent to the network in response to user input indicating a selection of a first profile associated with a UDN group of the one or more UDN groups.

At 506, the device may access the wireless network. For instance, in response to the primary access authentication, the device may access the wireless network (e.g., WLAN, etc.).

At 508, the device may send a second request to access a UDN group of the one or more UDN groups, the second request including second credentials associated with the UDN group. In some examples, the first request and/or second request is sent in response to user input selecting a profile associated with the UDN group.

At 510, the device may establish with the wireless network, a secondary EAP dialogue. For instance, as noted above, the device may establish the secondary EAP dialogue with a controller and/or authentication system.

At 512, the device may access the UDN group. For instance, the device may access the UDN group in response to the second credentials being authenticated by the network. As noted above, the device may access the UDN group for a period of time.

In some examples, the device may send a third request to access a second UDN group of the one or more UDN groups, wherein the third request comprises third credentials associated with accessing the second UDN group. For instance, the third request may be sent in response to user input indicating a selection of a second profile associated with the second UDN group. IN this example, the device is switching between UDN groups. The device may establish a secondary EAP dialogue with the network in order to authenticate the third credentials. In response to the third credentials being authenticated by the network, the device may access the second UDN group. As noted above, the device may access the second UDN group for a period of time.

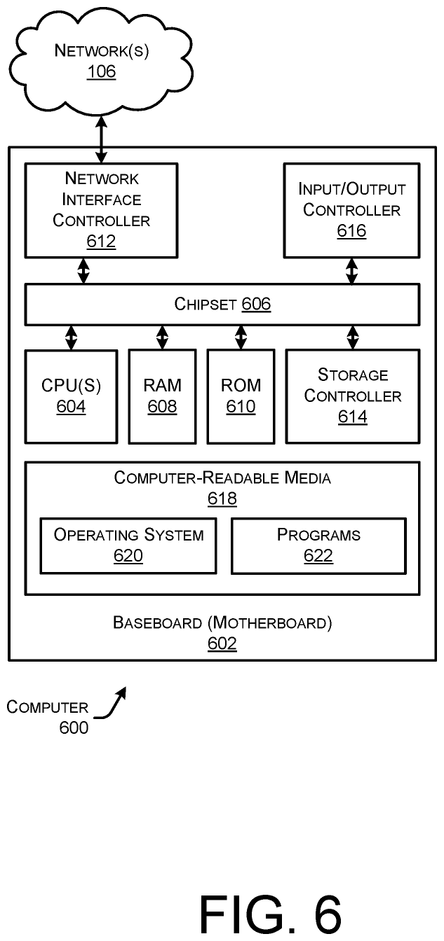

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a controller 110, network device 108, UDN cloud 112, authentication system(s) 116, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network(s) 106. The chipset 606 can include functionality for providing network connectivity through a NIC 612, such as a gigabit Ethernet adapter. The NIC 612 is capable of connecting the computer 600 to other computing devices over the network(s) 106. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the controller 110, network device 108, UDN cloud 112, authentication system(s) 116, and/or any components included therein, may be supported by one or more devices similar to computer 600. Stated otherwise, some or all of the operations performed by the controller 110, network device 108, UDN cloud 112, authentication system(s) 116, and or any components included therein, may be performed by one or more computer devices 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“MID”), high definition DVD (“I-ID-DVD”), or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a controller 110, network device 108, UDN cloud 112, authentication system(s) 116, and/or any other device. The computer 600 may include one or more hardware processors 604 (processors) configured to execute one or more stored instructions. The processor(s) 604 may comprise one or more cores. Further, the computer 600 may include one or more network interfaces configured to provide communications between the computer 600 and other devices, such as the communications described herein as being performed by the controller. 110, network device 108, UDN cloud 112, authentication system(s) 116, and/or any other device. The network interfaces may include devices configured to couple to personal area networks (PANS), user defined networks (UDNs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for performing UDN service authorization based on secondary identity credentials. For instance, the programs 622 may cause the computer 600 to perform techniques including receiving a first request to connect to the wireless network from a device of a user, the first request including first credentials; authenticating the first credentials; granting access to wireless network to the device; receiving, from the device, a second request to connect to a first user defined network (UDN) group within the wireless network, the second request including second credentials associated with the first UDN group; establishing, in response to the second request, a secondary EAP dialogue with the device; authenticating the second credentials associated with the first UDN group; granting access to the first UDN group to the device; and storing an indication that the device is associated with the first UDN group in a first list associated with the first UDN group.

Additionally, or alternatively the programs 622 may cause the computer 600 to perform techniques including: displaying, on a user interface of the device, one or more UDN groups within a wireless network, wherein each of the one or more UDN groups are associated with a respective profile of a user of the device; sending, from the device, a first request to access the wireless network, the first request including first credentials; accessing, by the device, the wireless network; sending, from the device, a second request to access a first UDN group of the one or more UDN groups, wherein the second request comprises second credentials associated with accessing the first UDN group; establishing, with the wireless network, a secondary EAP dialogue; and accessing, by the device, the first UDN group.

In this way, an end user may access a UDN group using secondary authentication that is exclusive to the UDN group. Accordingly, UDN service authorization is streamlined by eliminating the need to manually configure a user each time the user accesses a UDN group. Moreover, when a user switches between UDN groups, the user device is only required to perform secondary authentication for the UDN group (and not primary access authentication for the Wi-Fi network), thereby simplifying the UDN workflow and enabling dynamic UDN groups. Additionally, by providing multiple SSID profiles for the same SSID, with secondary identities specific to UDN groups, the current techniques eliminate the need to rely on MAC addresses as device identifiers.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a controller of a wireless network, the method comprising:
receiving a first request to connect to the wireless network from a device of a user, the first request including first credentials;
authenticating the first credentials;
granting access to wireless network to the device;
receiving, from the device, a second request to connect to a first user defined network (UDN) group within the wireless network, the second request including second credentials associated with the first UDN group;
establishing, in response to the second request, a secondary EAP dialogue with the device;
authenticating the second credentials associated with the first UDN group;
granting access to the first UDN group to the device; and
storing an indication that the device is associated with the first UDN group in a first list associated with the first UDN group.

2. The method of claim 1, further comprising:
receiving, from the device, a third request to connect to a second UDN group within the wireless network, the third request including third credentials associated with the second UDN group;
establishing, in response to the third request, a secondary EAP dialogue with the device;
authenticating the third credentials associated with the second UDN group;
granting access to the second UDN group to the device;
updating the first list to remove the device from the first UDN group; and
storing an indication that the device is associated with the second UDN group in a second list associated with the second UDN group.

3. The method of claim 2, wherein the wireless network comprises a plurality of UDN groups, including the first UDN group and the second UDN group, each respective UDN group being associated with a respective profile of the user.

4. The method of claim 1, wherein the second credentials comprise at least one of an identifier associated with the first UDN group or a username and password associated with the first UDN group.

5. The method of claim 1, wherein the first credentials are authenticated by an authentication service associated with the wireless network and the second credentials are authenticated by one of the authentication service or a third-party authentication service.

6. The method of claim 1, wherein the second credentials comprise a decorated network access identifier.

7. The method of claim 1, wherein the secondary EAP dialogue may comprise an identifier associated with the first UDN group.

8. The method of claim 1, further comprising:
sending, to the device and in response to authenticating the first credentials, a request for secondary credentials, the request including an identifier associated with the first UDN group;
receiving, from the device, a message including the second credentials; and
establishing, in response to receiving the second credentials, the secondary EAP dialogue with the device.

9. A system comprising:
one or more processors; and
one or more non-transitory computer-readable media storing computer-executable instructions that, when executed by the one or more processors, cause the one or more processors to perform operations comprising:
receiving, by a controller of a wireless network, a first request to connect to the wireless network from a device of a user, the first request including first credentials;
authenticating, by the controller, the first credentials;
granting, by the controller, access to wireless network to the device;
receiving, by the controller and from the device, a second request to connect to a first UDN group within the wireless network, the second request including second credentials associated with the first UDN group;
establishing, in response to the second request, a secondary EAP dialogue with the device;
authenticating, by the controller, the second credentials associated with the first UDN group;
granting, by the controller, access to the first UDN group to the device; and
storing, by the controller, an indication that the device is associated with the first UDN group in a first list associated with the first UDN group.

10. The system of claim 9, the operations further comprising:
receiving, from the device, a third request to connect to a second UDN group within the wireless network, the third request including third credentials associated with the second UDN group;
establishing, in response to the third request, a secondary EAP dialogue with the device;
authenticating the third credentials associated with the second UDN group;
granting access to the second UDN group to the device;
updating the first list to remove the device from the first UDN group; and
storing an indication that the device is associated with the second UDN group in a second list associated with the second UDN group.

11. The system of claim 10, wherein the wireless network comprises a plurality of UDN groups, including the first UDN group and the second UDN group, each respective UDN group being associated with a respective profile of the user.

12. The system of claim 9, wherein the second credentials comprise at least one of an identifier associated with the first UDN group or a username and password associated with the first UDN group.

13. The system of claim 9, wherein the first credentials are authenticated using an authentication service associated with the wireless network and the second credentials are authenticated using one of the authentication service or a third-party authentication service.

14. The system of claim 9, wherein the second credentials comprise a decorated network access identifier.

15. The system of claim 9, wherein the secondary EAP dialogue may comprise an identifier associated with the first UDN group.

16. The system of claim 9, the operations further comprising:
sending, to the device and in response to authenticating the first credentials, a request for secondary credentials, the request including an identifier associated with the first UDN group;
receiving, from the device, a message including the second credentials; and
establishing, in response to receiving the second credentials, the secondary EAP dialogue with the device.

17. A method comprising:
displaying, on a user interface of a device, one or more UDN groups within a wireless network, wherein each of the one or more UDN groups are associated with a respective profile of a user of the device;
sending, from the device, a first request to access the wireless network, the first request including first credentials;
accessing, by the device, the wireless network;
sending, from the device, a second request to access a first UDN group of the one or more UDN groups, wherein the second request comprises second credentials associated with accessing the first UDN group;
establishing, with the wireless network, a secondary EAP dialogue; and
accessing, by the device, the first UDN group.

18. The method of claim 17, further comprising:
creating, by the device, a first profile associated with the first UDN group and a second profile associated a second UDN group, wherein the first profile and the second profile comprise a same primary identifier, and wherein the first profile comprises a secondary identifier that is different from a secondary identifier of the second profile.

19. The method of claim 17, wherein the second request is sent in response to receiving user input selecting a first profile associated with the first UDN group.

20. The method of claim 17, further comprising:
sending, from the device, a third request to access a second UDN group of the one or more UDN groups, wherein the third request comprises third credentials associated with accessing the second UDN group;
establishing, with the wireless network, a secondary EAP dialogue; and
accessing, by the device, the second UDN group.
